(19) United States
(12) Patent Application Publication
(10) Pub. No.: US 2024/0182299 A1
(43) Pub. Date: Jun. 6, 2024

(54) REACTOR AND METHOD FOR THE PYROLYSIS OF HYDROCARBON-CONTAINING FLUIDS

(71) Applicants: thyssenkrupp Uhde GmbH, Dortmund (DE); thyssenkrupp AG, Essen (DE)

(72) Inventor: Nicolai ANTWEILER, Essen (DE)

(73) Assignees: thyssenkrupp Uhde GmbH, Dortmund (DE); thyssenkrupp AG, Essen (DE)

(21) Appl. No.: 18/281,920

(22) PCT Filed: Mar. 14, 2022
(86) PCT No.: PCT/EP2022/056534

§ 371 Date: Sep. 13, 2023

(30) Foreign Application Priority Data
Mar. 15, 2021 (DE) 10 2021 202 465.3

(51) Int. Cl. C01B 3/30; B01J 6/00

(52) U.S. Cl. CPC C01B 3/30; B01J 6/008; C01B 2203/0266; C01B 2203/085; C01B 2203/1241

(57) ABSTRACT

A reactor and a method at least for pyrolysis of hydrocarbon-containing fluids at least for production of at least hydrogen-containing fluids are disclosed, where the reactor has a reactor shell and a reactor shaft disposed within the reactor shell, and a reactor lining at least for thermal sealing of the reactor shaft with respect to the reactor shell is disposed between the reactor shell and the reactor shaft, and wherein the reactor shaft has an at least tetragonal geometry in cross section, wherein at least one electrode for generation of thermal energy is disposed on each of two mutually opposite side walls of the reactor shaft.

The present invention relates to a reactor and to a method at least for pyrolysis of hydrocarbon-containing fluids at least for production of at least hydrogen-containing fluids, wherein the reactor has a reactor shell and a reactor shaft disposed within the reactor shell, and a reactor lining at least for thermal sealing of the reactor shaft with respect to the reactor shell is disposed between the reactor shell and the reactor shaft. The invention further relates to a method at least for pyrolysis of hydrocarbon-containing fluids at least for production of at least hydrogen-containing fluids, wherein the hydrocarbon-containing fluids are fed to a reactor shaft of the reactor in countercurrent to a moving bed of the reactor that consists of particles.

### PRIOR ART

It is basic knowledge that strongly endothermic reactions that are known to occur in the chemical industry, for example in the cracking of mineral oil fractions or the reforming of natural gas or naphtha, necessitate temperatures especially in the range between 500° C. and 1700° C. in order to enable sufficient chemical breakdown. The reason for this is the thermodynamic limitation of the equilibrium conversion. The thermal breakdown of hydrocarbons also requires high temperatures, especially in the range from 800 to 1600° C. Particularly for methane pyrolysis as well, because of the thermodynamic equilibrium and the reaction kinetics, such high temperatures are required in order to achieve sufficiently high conversion rates, advantageously of more than 50%, within a very short period of time.

The prior art discloses different solutions that indicate the provision of high temperatures for enabling a pyrolysis method. For instance, documents U.S. Pat. Nos. 2,389,636 and 2,600,07, and also U.S. Pat. Nos. 5,486,216 and 6,670,058, describe the use of a solid-state bed as heat carrier medium. However, it should be noted here that this can result in disadvantageous occurrence of surface effects within the scope of adhesion, agglomeration and abrasion.

Oxidative methods as heat source are described, for example, in DE600 16 59T or U.S. Pat. No. 3,264,210. A disadvantage of the direct use of oxidative methods is, for example, the introduction of extraneous substances into the reaction zone, and consequently contamination of the products. There is also a risk that the carbon will burn off in an unwanted manner or the reactant stream will be burnt as well.

U.S. Pat. No. 2,799,640 or DE 1 266 273 each disclose an electrical heat source. A disadvantage here is considered to be the nonuniform heating of the reaction zone; this instability in the electrical heat input results in inhomogeneity within the reaction space in the pyrolysis, especially the pyrolysis of methane for production of hydrogen and pyrolysis carbon (CH4<->C+2H2). The thermal pyrolysis of methane is a highly endothermic reaction that takes place in a kinetically and thermodynamically advantageous manner within a temperature region of about 1000° C. and pressures up to 40 bar. The thermal cracking, in addition to hydrogen (H2), gives rise to pyrolysis carbon (C) as well, which is in turn an additional product of value. The hydrogen and the pyrolysis carbon are advantageously processed further or used further and serve as transport fuel or as combustion fuel in other drive systems, plants or branches of industry.

It can be considered to be basic knowledge that a bed of particles, especially a bed of carbon particles, is also used in pyrolysis, and the carbon-containing gas, such as methane gas, pyrolyzes thereon. The electrical input of heat, especially via resistance heating, is advantageously suitable for the provision of the enthalpy of reaction.

When a carbon bed is used, the electrical current, which is introduced into the reaction space, for example, via the use of electrodes or pairs of electrodes, flows through this bed and is dissipated into thermal energy because of the electrical resistance of the particle bed. The electrical resistance results from the contact points between the particles of the bed and the low transfer areas, while the carbon particles have high electrical conductivity. An essentially homogeneous input of heat into the heating zone of the reaction space requires electrical resistance which is at least intermittently homogeneous in sections over the entire cross-sectional area of the reaction space. However, it is known that pathways with different electrical resistance will always occur, such that the electrical current flows preferentially in the regions of lower electrical resistance. As a result, there is increased deposition of pyrolytic carbon in these regions, such that resistance is reduced ever further along these pathways of lower resistance. The consequence is inhomogeneities that lead to local hotspots, a local drastic reduction in electrical resistance, blockages, and ultimately failure of the heating. In-house studies have shown that known reactors, especially known reactor geometries (especially known reaction space geometries) and known methods of pyrolysis, for example of methane, result in a carbon formation in a central arrangement within the reaction space, said formation extending centrally along the reaction space in vertical longitudinal direction at least in sections. This carbon formation consists of coalesced carbon particles. This illustrates that the pyrolysis conducted has taken place not over the entire cross section of the reaction space but solely mainly in the center of the reaction space.

### DISCLOSURE OF THE INVENTION

The causes for the occurrence of the inhomogeneities in known reaction spaces and known pyrolysis methods, and consequently the failure of the heating concept of known reactors, have been the subject of in-house examination by the applicant. It has been found that, on account of the high ratio of wall area of the reaction space to reaction volume of the reaction space, there is a significant radial temperature profile. The higher temperature in the middle of the reaction space leads to higher conversions, i.e. to a higher deposition of carbon on the particles of the bed, and consequently to greater deposition of carbon from the carbon-containing gas, such as methane gas. The consequence is the lower electrical resistance in this region and consequently an associated preferential flow of current in the region of lower electrical resistance.

It is therefore an object of the present invention to at least partly to remedy the above-described disadvantages in known reactors and pyrolysis methods. In particular, it is an object of the present invention to provide a reactor and a method at least for pyrolysis of hydrocarbon-containing fluids, which enable, in a simple and inexpensive manner, essentially homogeneous heating of the reactor shaft over the cross section of the reactor shaft (reaction space), and consequently the generation and maintenance of an electrical field which is at least intermittently homogeneous in sections and has corresponding at least intermittently homogeneous resistance in sections.

The above object is achieved by a reactor at least for pyrolysis of hydrocarbon-containing fluids having the features of claim 1, and by a method at least for pyrolysis of hydrocarbon-containing fluids having the features according to claim 7. Further features and details of the invention will be apparent from the dependent claims, the description and the drawings. Features and details that are described in connection with the reactor of the invention are of course also applicable in connection with the method of the invention, and vice versa in each case, such that, with regard to the disclosure relating to the individual aspects of the invention, reference is always made, or may be made, to the alternate subjects. Moreover, the method of the invention may be conducted with the reactor of the invention.

The reactor of the invention at least for pyrolysis of hydrocarbon-containing fluids at least for production of at least hydrogen-containing fluids has a reactor shell and a reactor shaft disposed within the reactor shell. A reactor lining at least for thermal sealing of the reactor shaft with respect to the reactor shell is disposed between the reactor shell and the reactor shaft. According to the invention, the reactor shaft has an at least tetragonal geometry in cross section, where at least one electrode for generation of thermal energy is disposed on each of two mutually opposite side walls of the reactor shaft. It is additionally conceivable that the reactor lining also serves for electrical insulation, such that the electrical energy generated by the electrodes is not released to the outside environment of the reactor. Fluids in the context of the invention are also understood to mean gases or liquids. Hydrocarbon-containing fluids may accordingly, for example, be methane (methane gas), natural gas or blue gas. The term “hydrocarbon-containing fluids” in the context of the invention is consequently understood to mean all fluids (gases/liquids) that contain hydrocarbon, which can be dissociated by a pyrolysis method to carbons and hydrogens. The reactor shell of the reactor advantageously has a geometry of annular/circular cross section. This is advantageous in order to withstand high pressures in particular. However, it would also be conceivable for the reactor shell, by comparison with the reactor shaft, which can also be referred to as reaction space, likewise to have a geometry of at least tetragonal cross section, and particularly advantageously one matching the geometry of the reactor shaft. The reactor shaft may advantageously also have a geometry of rectangular cross section, especially a square geometry. However, it would also be conceivable for the reactor shaft to have a cross section of polygonal, especially pentagonal or higher polygonal geometry. There are particularly advantageously at least two opposite walls, especially inner walls of the reactor shaft, viewed in the cross section of the reactor shaft, that are parallel to and opposite one another. The electrodes for generating an electrical field which is at least intermittently homogeneous in sections, especially an essentially homogeneous electrical field, are disposed on these parallel and mutually opposite walls within the reactor shaft. Advantageously, the electrodes are also opposite one another, i.e. at the same height—viewed in longitudinal direction of the reactor shaft. Particularly advantageously, the electrodes are disposed on the inside of the side walls of the reactor shaft. The arrangement of the electrodes advantageously provides direct electrical resistive heating of the particles of the moving bed, especially the particle bed. The tetragonal, especially rectangular, especially square, geometry of the reactor shaft and the correspondingly described arrangement of the electrodes enable the creation of an electrical potential field which is at least intermittently homogeneous in sections between the mutually opposite electrodes. In addition, this prevents any slippage from arising in respect of the streams of matter, and an associated reduction in conversion.

It is conceivable that the particles of the moving bed have a size of 0.5 mm to 20 mm, preferably of 1 mm to 10 mm. The method of pyrolysis of the hydrocarbon-containing fluid advantageously takes place at pressures of 1 bar to 50 bar, preferably of 5 bar to 30 bar. Temperatures generated here are mainly from 800° C. to 1600° C., preferably from 1000° C. to 1400° C.

In one embodiment, the mutually opposite electrodes, viewed in vertical longitudinal direction of the reactor, are disposed in the middle of the reactor shaft at least in sections. This means that at least a section of each reactor is in contact with or extends up to a (theoretical) centerline (midpoint of the reactor in longitudinal direction/viewed in longitudinal section) of the reactor, while the remaining section of the respective electrode is disposed in a reactor shaft region that exists beneath or above this theoretical centerline. More specifically, it would be conceivable for the respective electrodes to be disposed in a section of the reactor shaft facing the head of the reactor or in a region of the reactor shaft facing the bottom (base) of the reactor. Alternatively, however, it is also conceivable for the respective electrodes to be disposed exactly in the middle of the reactor shaft (in longitudinal direction/viewed in longitudinal section). Alternatively, it is conceivable that neither of the electrodes of an electrode pair, viewed in vertical longitudinal direction of the reactor, is disposed in the middle of the reactor shaft at least in sections at the reactor shaft wall or side wall of the reactor shaft. Instead, the electrodes are then disposed exclusively in a reactor shaft region that exists below or above this theoretical centerline at the reactor shaft wall.

In one embodiment, there are at least two or more electrodes for generation of thermal energy disposed on each of the two mutually opposite side walls of the reactor shaft. Advantageously, there are always two of the mutually opposite electrodes disposed at the same height—viewed in longitudinal direction of the reactor shaft—such that these electrodes form an electrode pair, especially a mutually opposite electrode pair. More specifically, it is conceivable that a multitude of electrode pairs is disposed in the reactor. The electrodes here may have a wide variety of different geometric configurations. It is accordingly conceivable that the electrodes of an electrode pair have a tetragonal, especially rectangular or else square, configuration. Likewise conceivable are circular, oval/elliptical or polygonal electrodes. It is also possible to use the electrodes in the form of a mesh, also called mesh electrodes. The geometric shaping and configuration of the electrodes is not to be restricted to a defined shape in the context of the invention. However, it is advantageous when both electrodes of an electrode pair have a mutually identical, but at least comparable, geometric shape. In addition, it would also be possible if electrode pairs used within a reactor, especially at the side wall of the reactor shaft, each have a mutually different shape. This may be advantageous with regard to the resultant difference in electrical fields and the associated different heat input in the different height regions of the reactor shaft. The use or arrangement of multiple electrode pairs within the reactor shaft advantageously enables the establishment of different axial temperature zones. Accordingly, it is advantageous in the case of different resistance characteristics of the particle material of the moving bed that controlled adjustment of the temperature via field parameters is possible.

In addition, at least one of the electrodes per side wall of the reactor shaft, viewed in vertical longitudinal direction of the reactor, is disposed in the middle of the reactor shaft at least in sections, or each of the electrodes per side wall is disposed at least above or below the middle of the reactor shaft. More specifically, in the case of arrangement of two or more electrode pairs in the reactor shaft, either at least one electrode pair is disposed in the middle region of the reactor shaft such that at least a section of each electrode of this electrode pair makes contact with a (theoretical) centerline of the reactor shaft (viewed in longitudinal direction of the reactor shaft). This may be a middle electrode pair or else one of the outer electrode pairs. Or the electrode pairs are each above a theoretical centerline or below said theoretical centerline, or frame said theoretical centerline such that at least one electrode pair is disposed above and at least one electrode pair below said theoretical centerline, where none of the electrode pairs, especially the electrodes of one electrode pair, make contact with this theoretical centerline.

Advantageously, the electrodes are arranged in such a way that these electrodes generate an electrical field which is essentially homogeneous when viewed in cross section, especially an electrical field which is at least intermittently homogeneous in sections. This electrical field (potential field) advantageously extends horizontally over the entire width and depth (area) of the reactor shaft.

In one embodiment, the reactor has a reactor head and a reactor bottom, which can also be referred to as reactor base. The reactor head and the reactor bottom each have at least intermittently closable feed openings and discharge openings through which at least fluids, such as gases or liquids, and/or solids, especially particles, can be introduced or discharged, such that, for creation of a moving bed, particles are continuously introduced into the reactor shaft at least intermittently through the reactor head. Rather than a moving bed, it is also conceivable to use a fluidized bed. The moving bed advantageously transports particles, especially carbon-containing particles, into the reactor, especially into the reactor shaft of the reactor, and advantageously moves/transports them through the reactor shaft—proceeding from the reactor head down to the reactor bottom. Advantageously, the particles of the moving bed, or the bed, migrate(s) in a gravity-driven and/or gravimetric manner through the reactor shaft. The particles of the moving bed then take up the carbon in the hydrocarbon-containing fluids introduced into the reactor shaft and advantageously transport it out of the reactor shaft via the reactor bottom. In the case of pyrolysis of methane, the particles heat up, and methane breaks down preferentially on the heated particles. A portion will also break down in the intermediate volume and be discharged in the manner described. The continuous outward transport of the carbon or of the carbon-containing particles ensures the maintenance of the desired electrical field which is at least intermittently homogeneous in sections, and consequently the essentially homogeneous distribution of heat at least in the heating zone of the reactor shaft. The feed openings and discharge openings advantageously enable continuous introduction or discharge of the substances to be reacted or of the gases already freed of carbon by the pyrolysis.

It is additionally conceivable that the electrodes are arranged in such a way that these generate an electrical field aligned orthogonally at least in sections to the direction of movement of the particles of the moving bed that move through the reactor shaft. Advantageously, the electrodes, because of their arrangement in the reactor shaft, i.e. because of their arrangement on two mutually opposite side walls of the reactor shaft at mutually identical height, generate an electrical field aligned fully orthogonally to the direction of movement of the moving bed, especially the particles of the moving bed. The moving bed, as described above, migrates through the reactor shaft from the top downward, i.e. proceeding from the reactor head, through which the particles of the moving bed are introduced into the reactor shaft, down to the reactor bottom, which can also be referred to as reactor base. The particles of the moving bed are then discharged from the reactor shaft via corresponding exit openings. Based on the orthogonal alignment of the electrical field relative to the particles of the moving bed, uniform heating of the particles of the moving bed advantageously takes place, such that these particles can consequently serve to take up carbon from carbon-containing fluids over the entire plane—viewed in cross-sectional direction—of the reactor shaft. This advantageously avoids the occurrence of local hotspots.

In a second aspect of the invention, a method at least for pyrolysis of hydrocarbon-containing fluids, for example gases or liquids, at least for production of at least hydrogen-containing fluids, for example gases or liquids, is claimed. According to the invention, the hydrocarbon-containing fluids are fed to a reactor shaft—which may also be referred to as reaction space—of a reactor in countercurrent to a moving bed of the reactor that consists of particles. According to the invention, at least the particles of the moving bed or the hydrocarbon-containing fluids, by means of electrodes for generation of thermal energy that are disposed in the reactor shaft, are heated up to a defined temperature in the range between 800-1600° C., preferably between 800-1500° C., more preferably between 800-1400° C. More specifically, it is conceivable that either the particles of the moving bed or the hydrocarbon-containing particles or both, i.e. the particles of the moving bed and the hydrocarbon-containing fluids, are heated (up) by means of the electrical energy generated by the electrodes. Advantageously, pyrolysis takes place, i.e. dissociation of carbons and hydrogens from the hydrocarbon-containing fluids over and above a temperature of about 800° C. Advantageously, the electrodes, mainly in conjunction with an electrical resistance, such as, in particular, of the particle bed or the particles of the moving bed, generate heat in that the electrical energy is dissipated into thermal energy.

Advantageously, the method is conducted in a reactor according to the first aspect of the invention, i.e. of the aforementioned type. Accordingly, the features detailed with regard to the first aspect of the invention, i.e. with regard to the reactor of the invention, are referenced in full here.

It is conceivable that the particles of the moving bed migrate downward in a gravimetric, especially gravity-driven, manner from a reactor head of the reactor to a reactor bottom of the reactor in vertical longitudinal direction of the reactor. Accordingly, the particles of the moving bed are fed to the reactor shaft through one or more feed openings within the reactor head and migrate through the reactor shaft in the direction of the reactor bottom. The reactor bottom advantageously has one or more discharge openings through which the particles, which are advantageously now laden with carbon, are withdrawn from the reactor shaft.

Advantageously, the electrodes disposed in the reactor shaft, especially at a side wall or inner wall of the reactor shaft, generate an electrical field aligned orthogonally at least in sections, advantageously over the full extent, to the direction of movement of the particles of the moving bed that move through the reactor shaft. Accordingly, the electrical field extends essentially horizontally, viewed in cross-sectional direction. Meanwhile, the particles, viewed in longitudinal direction or longitudinal section direction, migrate essentially vertically through the reactor shaft. This advantageously enables heating, essentially over the full extent, at least of the particles of the moving bed at least within the heating zone of the reactor shaft, and avoids or at least counteracts the formation of local hotspots within the reactor shaft.

In one embodiment, a first heat integration zone, a reaction zone, a heating zone and a second heat integration zone are formed within the reactor shaft. The individual zones, proceeding from the reactor bottom (also called reactor base) of the reactor up to the reactor head of the reactor, viewed in vertical longitudinal direction of the reactor, are successive and overlap at least partly in sections. More specifically, there are zones that overlap and/or zones that adjoin one another without overlapping. The heating zone forms mainly in the region of the reactor shaft in which the electrodes are disposed. It is conceivable that the heating zone and the reaction zone overlap at least in sections. This means conversely that a reaction, i.e. a dissociation, especially the splitting of the carbon away from the hydrocarbon-containing fluids, already takes place—at least in part—outside the heating zone, especially in the reaction zone. The individual zones are elucidated in detail once again hereinafter—in the description of the figures.

Advantageously, pyrolysis takes place at least in the reaction zone or in the heating zone. More specifically, it is conceivable that the pyrolysis, i.e. the breakdown of the hydrocarbon-containing fluids, especially gases, and consequently the splitting of the carbons away from the hydrocarbon-containing fluids takes place either in the reaction zone or in the heating zone or in both zones. Advantageously, pyrolysis takes place in an overlap region of the two zones, as described above.

It is additionally conceivable that the hydrocarbon-containing fluids are already at least preheated in the first heat integration zone by the particles of the moving bed which have already passed through the heating zone and move in countercurrent to the hydrocarbon-containing fluids. More specifically, the hydrocarbon-containing fluids are introduced, especially blown, into the reactor shaft via the reactor bottom (also called reactor base), especially via at least one feed opening. Accordingly, the hydrocarbon-containing fluids, proceeding from the reactor base, move upward through the reactor shaft to the reactor head essentially in vertical direction. This flow of hydrocarbon-containing particles is opposed by a flow of particles of the moving bed, which migrates essentially vertically downward proceeding from the reactor head through the reactor shaft to the reactor bottom. On the route of the particles of the moving bed through the reactor shaft, the particles, before arriving in the first heat integration zone, have already passed through at least the heating zone and absorbed heat/thermal energy within that heating zone. When the particles of the moving bed then meet the hydrocarbon-containing fluid in the first heat integration zone, the particles of the moving bed release heat (thermal energy) to the hydrocarbon-containing fluid. Consequently, in the first heat integration zone, hydrocarbon-containing fluid is already preheated before it reaches the heating zone. It is conceivable that the hydrocarbon-containing fluid is preheated to a temperature between 600-800° C. in the first heat integration zone. If a temperature of at least 800° C. is attained during flow through the first heat integration zone, the reaction zone forms over and above this temperature, in which the carbons are split off from the hydrocarbon-containing fluids and deposited on the particles of the moving bed. Accordingly, it is possible that the pyrolysis of the hydrocarbon-containing fluid already commences in a reaction zone that develops because of the thermal energy brought in by the particles of the moving bed. It is likewise conceivable that the hydrocarbon-containing fluids that are introduced into the reactor shaft of the reactor are already preheated before entry and consequently flow into the reactor shaft in preheated form. It is conceivable here to preheat the hydrocarbon-containing fluids to a temperature of, for example, not more than 600° C., advantageously to a temperature of less than 800° C. As a result, it is consequently possible, after introduction of the preheated hydrocarbon-containing fluids into the reactor shaft, to accelerate the development of a reaction zone. In particular, the preheated hydrocarbon-containing fluids can be heated more quickly to a temperature of at least 800° C. in the first heat integration zone than non-preheated hydrocarbon-containing fluids. Based on the quicker development of the reaction zone through attainment of the pyrolysis temperature of 800° C., pyrolysis can consequently also be effected more quickly (by comparison with pyrolysis in the case of hydrocarbon-containing fluids that have not been introduced in preheated form), such that the entire pyrolysis process can be performed in a more energy-efficient or energetically efficient manner. In the case of preheating of the hydrocarbon-containing fluids outside the reactor or at least outside the reactor shaft (reaction space), however, it has to be ensured that the temperature (pyrolysis temperature) of 800° C. is not attained or even exceeded, in order to enable the pyrolysis to take place within the reactor shaft.

Advantageously, the particles of the moving bed that enter the reactor shaft have already been at least preheated in the second heat integration zone by a heated hydrogen-containing fluid which flows in countercurrent to the particles of the moving bed, results from the hydrocarbon-containing fluids and has already passed through the heating zone and released carbon. The second heat integration zone is accordingly a zone upstream of the heating zone, viewed from the reactor head in the direction of the reactor bottom of the reactor. The hydrocarbon-containing fluids that split off carbons at least in the reaction zone and advantageously also in the heating zone then flow through the second heat integration zone as hydrogen-containing fluids that introduce corresponding heat (thermal energy) from the reaction zone and ultimately also introduce it from the heating zone into the second heat integration zone. This thermal energy is then transferred to the particles of the moving bed, which are advantageously introduced into the reactor shaft in non-preheated form. Consequently, the particles of the moving bed have already been preheated in the first heat integration zone by the thermal energy of the hydrogen-containing fluids before these reach the heating zone.

In one embodiment, the carbon-laden particles in the moving bed are discharged from the reactor shaft via the reactor bottom of the reactor. It is conceivable that the particles of the moving bed are sent to downstream processes which clean the particles, i.e. free the particles of carbon, or which send the carbon-laden particles to further chemical processes for further processing. At least some of the particles of the moving bed grow in terms of size because of the reaction that has taken place. The particles that have grown, especially large particles, are discharged primarily from the process, while the small particles that have remained unchanged, especially virtually unchanged, in size are recirculated. It is additionally conceivable that at least a portion of the grown (large) particles are crushed and/or ground, especially comminuted, where these comminuted particles are fed back to the process.

All the advantages that have already been described for a reactor according to the first aspect of the invention arise in the method described.

It will be apparent that the features specified above and those that are yet to be elucidated hereinafter are usable not just in the particular combination specified but also in other combinations or on their own, without leaving the scope of the present invention.

Embodiments of the reactor of the invention and of the method of the invention are elucidated in detail hereinafter with reference to drawings. The figures show, each in schematic form:

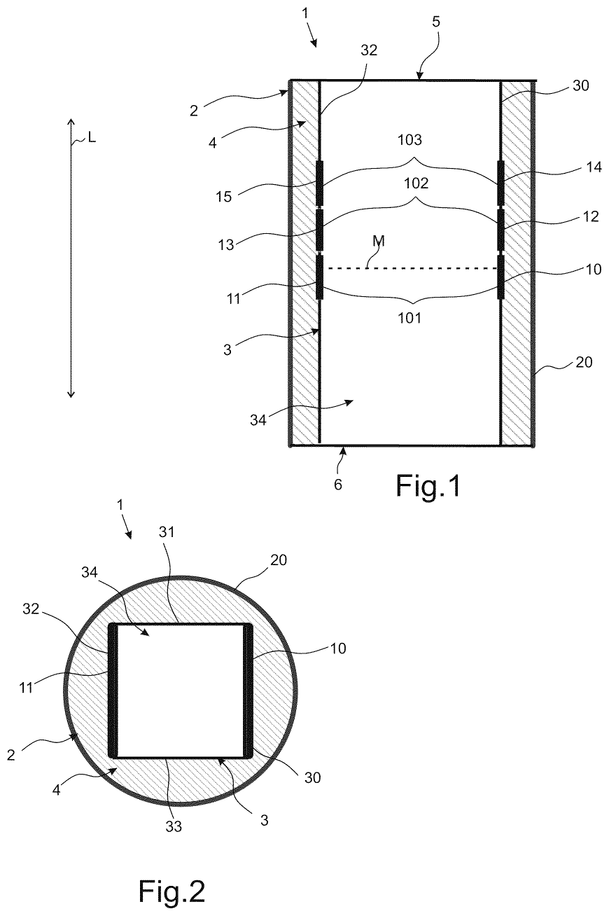

FIG. 1 in a section diagram, a side view of one embodiment of the reactor of the invention,

FIG. 2 in a section diagram, a top view of the embodiment of the reactor of the invention shown in FIG. 1,

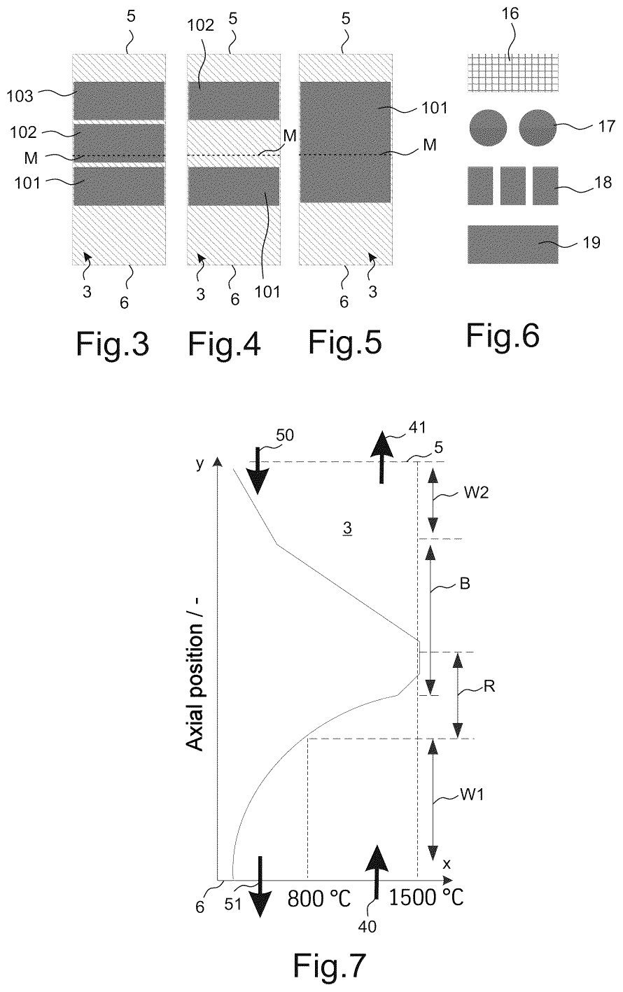

FIG. 3 in a section diagram, a front view of an arrangement of electrodes of one embodiment of the reactor of the invention,

FIG. 4 in a section diagram, a front view of a further arrangement of electrodes of one embodiment of the reactor of the invention,

FIG. 5 in a section diagram, a front view of a further arrangement of electrodes of one embodiment of the reactor of the invention,

FIG. 6 a top view of different geometries of electrodes, and

FIG. 7 an illustrative temperature profile of one embodiment of the reactor of the invention for illustration of the method of the invention.

Elements having the same function and mode of action are each given the same reference symbols in FIGS. 1 to 7.

FIG. 1 shows, in schematic form, in a section diagram, a side view of one embodiment of an inventive reactor 1. More specifically, this is a longitudinal section through one embodiment of the inventive reactor 1. FIG. 2 shows, in a section diagram, a top view of the embodiment of the inventive reactor 1 shown in FIG. 1. More specifically, FIG. 2 shows a cross section through the embodiment of the inventive reactor 1 shown in FIG. 1, which extends essentially along the centerline M shown in FIG. 1. The reactor 1 is consequently cut down the middle, i.e. in the middle, according to FIG. 2. Therefore, FIGS. 1 and 2 will be described collectively hereinafter. The reactor 1 has a reactor shell 2 which has a circular geometric shape in cross section and extends like a tower in longitudinal direction L. The reactor shell 2 is fully closed and consequently has a closed reactor shell wall 20 which is circular in cross section. Within the reactor shell 2 or reactor shell wall 20 is disposed a reactor shaft 3. The reactor shaft 3 has a geometric shape which is tetragonal, especially square, in cross section and extends like a tower in longitudinal direction L. Consequently, the reactor shaft 3 comprises at least four side walls 30, 31, 32, 33, especially reactor shaft walls 30, 31, 32, 33. At least two of the side walls 30, 31, 32, 33, especially the first side wall 30 and the third side wall 32, lie parallel to one another. The reactor shaft 3 is a reaction space that consequently has a reaction volume 34 within which the chemical reaction, especially the pyrolysis of hydrocarbon-containing fluids, primarily hydrocarbon-containing gases, takes place. A reactor lining 4 is provided between the reactor shaft 3, especially the side walls 30, 31, 32, 33 of the reactor shaft 3 and the reactor shell 2, especially the reactor shell wall 20. This reactor lining 4 advantageously extends fully between the reactor shaft 3 and the reactor shell 2 in circumferential direction and in longitudinal direction L. The reactor lining 4 serves primarily to shield the reactor shell from thermal energy which is introduced into the reaction volume 34 of the reactor shaft 3. In addition, FIGS. 1 and 2 show a total of six electrodes 10, 11, 12, 13, 14, 15, which are disposed on the reactor shaft 3, more specifically on the first side wall 30 and on the third side wall 32 of the reactor shaft 3. Accordingly, three electrodes 10, 12 and 14 are disposed on the first side wall 30, while three further electrodes 11, 13 and 15 are disposed on the third side wall 32. Advantageously, the respective electrodes 10, 11, 12, 13, 14, 15, viewed in cross-sectional direction, extend over the entire width of the side walls 30, 32. The second side wall 31 and the fourth side wall 33 mainly have no electrodes. Respectively opposite electrodes 10, 11, 12, 13, 14, 15 form an electrode pair 101, 102, 103. For instance, the electrodes 10 and 11 form the first electrode pair 101, the electrodes 12 and 13 the second electrode pair 102, and the electrodes 14 and 15 the third electrode pair 103. Advantageously, the respective electrodes 10, 11, 12, 13, 14, 15 of an electrode pair 101, 102, 103, viewed in longitudinal direction L, are at the same height. The reference symbol M indicates the feature of the centerline. This (theoretical) centerline M consequently defines the middle of the reactor 1 viewed in longitudinal direction L, especially of the reactor shaft 3. The electrodes 10, 11, 12, 13, 14, 15 are disposed primarily in the region of, specifically in the vicinity of, the centerline M. As shown in FIG. 1 in particular, at least the first electrode pair 101 composed of electrodes 10 and 11 makes contact with the centerline in sections. The second electrode pair 102 composed of electrodes 12, 13 and the third electrode pair 103 composed of electrodes 14, 15, by contrast, are shifted above the centerline M, i.e. in the direction of the reactor head 5 of the reactor 1, especially in a section of the reactor shaft 3 that extends between the centerline M and the reactor head 5. The section of the reactor shaft 3 that extends from the centerline M in the direction of the reactor bottom 6, by contrast, has no further electrode pairs. The arrangement of the electrodes 10, 11, 12, 13, 14, 15 within the reactor shaft 3, with regard to the height of the reactor shaft 3 that extends in longitudinal direction L, may be designed individually and is decided by the desired position of the heating zone and of the resultant reaction zone. More specifically, the positioning of the electrodes 10, 11, 12, 13, 14, 15 is accordingly also dependent on whether the heating zone is to be formed in an upper region or lower region of the reactor shaft 3 relative to the centerline M. This variable positioning of the electrodes 10, 11, 12, 13, 14, 15 is also shown, for example, in FIGS. 3, 4 and 5 that follow.

FIGS. 3, 4 and 5 each show, in a section diagram, a front view of an arrangement of electrodes in one embodiment of the inventive reactor 1.

As shown in FIG. 3, the three electrode pairs 101, 102, 103 used here are positioned within the reactor shaft 3 such that the electrodes of the second electrode pair 102 make contact with the (theoretical) centerline M at least in sections and are consequently disposed in the middle of the reactor shaft 3 in at least one section. The remaining electrode pairs 101 and 103 are then disposed within the reactor shaft 3 at a distance from the centerline M. Thus, the electrodes of the first electrode pair 101 are disposed in a region of the reactor shaft 3 between the centerline M and the reactor bottom 6, i.e. in a lower region relative to the centerline M, while the electrodes of the third electrode pair 103 are disposed in a region of the reactor shaft 3 between the centerline M and the reactor head 5, i.e. in an upper region relative to the centerline M.

As shown in FIG. 4, the arrangement of only two electrode pairs 101 and 102 is also conceivable, where neither of the electrode pairs 101, 102, especially none of the electrodes of the respective electrode pair 101, 102, makes contact with the theoretical centerline M even in sections. Instead, the electrodes of the first electrode pair 101 are disposed in a region of the reactor shaft 3 between the centerline M and the reactor bottom 6, i.e. in a lower region relative to the centerline M, while the electrodes of the second electrode pair 102 are disposed in a region of the reactor shaft 3 between the centerline M and the reactor head 5, i.e. in an upper region relative to the centerline M.

Also conceivable is the configuration by means of only one electrode pair 101, as shown in FIG. 5. In this case, the respective electrodes of this electrode pair 101 make contact with the (theoretical) centerline M at least in sections and advantageously extend across this centerline M into the upper region of the reactor shaft 3 formed between the centerline M and the reactor head 5, and likewise in the lower region of the reactor shaft 3 formed between the centerline M and the reactor bottom 6. The electrodes of the electrode pair 101 are arranged primarily in such a way that there is a larger area of the respective electrode of the electrode pair 101 in the upper region of the reactor shaft 3. The electrodes of the electrode pair 101, i.e. the electrode pair 101, are consequently disposed slightly offset toward the top, viewed with respect to the centerline M.

Alternative positions of the electrodes per electrode pair 101, 102, 103 and an alternative number of electrode pairs 101, 102, 103 are conceivable. This means that it is also possible for more than three electrode pairs 101, 102, 103 to be arranged within a reactor shaft 3. However, not only the number and positioning of the electrode pairs 101, 102, 103 within a reactor shaft 3 may vary.

As shown in FIG. 6, the electrodes 10, 11, 12, 13, 14, 15 may also have different geometric configurations. For instance, the use of mesh electrodes 16 or circular electrodes 17 is conceivable, as is the use of tetragonal, especially rectangular, electrodes 18, 19. The size of the electrodes 16, 17, 18, 19 may also be different. For example, the dimensions of the rectangular, large-area electrode 19 may be such that it encompasses essentially the size of at least two, especially three or more, rectangular electrodes 18 and consequently may also be disposed in the reactor shaft alone or together with an electrode 19 of the same geometry to create an electrode pair. The use or arrangement of multiple electrode pairs 101, 102, 103 within the reactor shaft 3 advantageously enables the establishment of different axial temperature zones. Accordingly, in the case of different resistance characteristics of the particle material of the moving bed, controlled adjustment of the temperature via field parameters is advantageously possible.

FIG. 7 shows an illustrative temperature profile of an embodiment of the inventive reactor 1 for illustration of the method of the invention. The temperature profile of FIG. 7 is elucidated in conjunction with the fundamental construction of the reactor 1 as shown, for example, in FIGS. 1 and 2. The temperature is plotted on the x axis of the temperature profile. Threshold values specified by way of example are 800° C. and 1500° C. The axial extent of the reactor shaft 3 in longitudinal direction L is shown on the y axis. The thermal evolution shown in FIG. 7 takes place in the reaction volume 34 of the shaft 3 of an inventive reactor 1. Hydrocarbon-containing fluids 40 are introduced into the reactor shaft 3, especially into the reaction volume 34 of the reactor shaft 3, via inlet openings/feed openings in the reactor bottom 6 that are not shown here, and particles 50 of the moving bed via inlet openings/feed openings in the reactor head 5 that are not shown here. The hydrocarbon-containing fluids 40 flow through the reactor shaft 3 proceeding from the reactor bottom 6 in the direction of the reactor head 5. The particles 50 of the moving bed migrate in the opposite direction proceeding from the reactor head 5 in the direction of the reactor bottom 6 through the reactor shaft 3. The hydrocarbon-containing fluids 40 may already have been preheated before entry into the reactor shaft 3. Possible temperatures are below 800° C., especially essentially about 600° C. However, it is also conceivable that the hydrocarbon-containing fluids 40 are introduced into the reactor shaft 3 without preheating. Essentially at the same time, the particles 50 of the moving bed are also introduced into the reactor shaft 3 and, on their way through the reactor shaft 3 down to the reactor bottom 6, migrate through the second heat integration zone W2, the heating zone B, the reaction zone R and the first heat integration zone W1. In the second heat integration zone W2, which forms between the heating zone B and the reactor head 5, the particles 50 of the moving bed are preheated within the reactor shaft 3. This is accomplished by transfer of thermal energy, which is transferred to the particles 50 of the moving bed from heated hydrogen-containing gases 41 which, coming from the heating zone B, leave the reactor shaft 3 via exit openings/discharge openings within the reactor head 5 that are not shown here. In the second heat integration zone W2, consequently, integration of heat/thermal energy from the gas phase to the solid phase advantageously takes place. The hydrogen-containing gases 41 are a reaction product formed as a result of the pyrolysis of the hydrocarbon-containing fluids 40 introduced into the reactor shaft 3. The pyrolysis advantageously takes place in the reaction zone R and at least partly also in the heating zone B, and advantageously (also) in the region of the overlap of reaction zone R and heating zone B. In order to trigger the pyrolysis, i.e. the dissociation of hydrocarbons, thermally into the carbon and hydrogen constituents, and consequently the splitting of carbon away from the hydrocarbon-containing fluids 40, a minimum temperature of about 800° C. is required. This minimum temperature has advantageously already been attained after passage through a first heat integration zone W1. In this first heat integration zone W1, thermal energy is transferred, proceeding from the laden particles 51 of the moving bed that have already migrated through the heating zone B on their way to the reactor bottom 6, to the hydrocarbon-containing fluids 40 that are flowing in the direction of the heating zone B. In the first heat integration stage W1, consequently, integration of heat/thermal energy from the solid phase to the gas phase advantageously takes place. The closer the hydrocarbon-containing fluids 40 come to the heating zone B, the warmer they become, because of the constant absorption of thermal energy via the laden particles 51 of the moving bed. Laden particles 51 of the moving bed are understood in the context of this invention to mean particles that have already taken up carbon or carbon atoms from the hydrocarbon-containing fluids 40. The carbons are deposited mainly on and between the particles 50 of the moving bed. This deposition affects the electrical resistance characteristics of the moving bed, or of the bed of the moving bed, that migrates gravimetrically through the reactor shaft 3. By virtue of the arrangement of electrodes 10, 11, 12, 13, 14, 15 shown by way of example in FIG. 1 within an at least tetragonal reactor shaft 3 and the resulting electrical potential field, and also the flow direction of the moving bed, the moving bed or the particles 50 of the moving bed move(s) new particle material into the heating zone B, and consequently prevent(s) any adverse effect on the resistance characteristics mentioned. The heating zone B in the context of the invention is understood to mean a zone within which the electrodes 10, 11, 12, 13, 14, 15 are positioned or disposed at least in sections, advantageously completely. More specifically, the electrodes 10, 11, 12, 13, 14, 15, because of their heat input, generate the heating zone B. The electrodes 10, 11, 12, 13, 14, 15 advantageously do not hinder the flow of particles 50 of the moving bed. On attainment of heating of the hydrocarbon-containing fluids of about 800° C., the pyrolysis process consequently commences and the reaction zone R is formed. This means that the carbons of the hydrocarbon-containing fluids 40 migrate in the direction of the particles 50 or else of the at least partly already laden particles 51 of the moving bed. This chemical reaction process may accordingly also proceed upstream of the heating zone B and accordingly before reaching the zone which is formed by the electrodes 10, 11, 12, 13, 14, 15, solely through the heating of the hydrocarbon-containing fluids 40 by the thermal energy of the laden particles 51 of the moving bed. Within the heating zone B, the particles 50 of the moving bed and hence consequently also the hydrocarbon-containing fluids 40 are heated to a maximum temperature of advantageously 1200° C. to 1700° C. Within this heating zone B, the pyrolysis progresses, until essentially all carbons have been transferred from the hydrocarbon-containing fluids 40 to the particles 50 of the moving bed. What remain are the hydrogen-containing fluids 41 and the laden or at least partly laden particles 51 of the moving bed. Accordingly, it is also conceivable that the chemical reaction is already complete, even though the hydrocarbon-containing fluids 40 have not yet flowed fully through the heating zone B. Accordingly, it is conceivable that the reaction zone R does not additionally encompass the entire length of the heating zone B, but also merely partly overlaps it.

### LIST OF REFERENCE SYMBOLS

1 reactor
2 reactor shell
3 reactor shaft
4 reactor lining
5 reactor head
6 reactor bottom
10, 11, 12,
13, 14, 15 electrodes
16 mesh electrode
17 circular electrode
18 tetragonal/rectangular electrode
19 tetragonal large electrode
20 reactor shell wall
30, 31,
32, 33 reactor shaft walls/side walls
34 reaction volume
40 hydrocarbon-containing fluid
41 hydrogen-containing fluid
50 unladen particles of the moving bed
51 laden particles of the moving bed
101,102,103 electrode pair
B heating zone
L longitudinal direction
M centerline
R reaction zone
W1 first heat integration zone
W2 second heat integration zone
x, y axes

1-15. (canceled)

16. A reactor at least for pyrolysis of hydrocarbon-containing fluids and at least for production of at least hydrogen-containing fluids comprising:
a reactor shell and a reactor shaft disposed within the reactor shell;
a reactor lining at least for thermal sealing of the reactor shaft with respect to the reactor shell disposed between the reactor shell and the reactor shaft, wherein the reactor shaft includes an at least tetragonal geometry, where at least one electrode for generation of thermal energy is disposed on each of two mutually opposite side walls of the reactor shaft.

17. The reactor of claim 16, wherein the mutually opposite electrodes, viewed in vertical longitudinal direction (L) of the reactor, are disposed in the middle of the reactor shaft at least in sections.

18. The reactor of claim 16, wherein at least two or more electrodes for generation of thermal energy are disposed on each of the two mutually opposite side walls of the reactor shaft, and where at least one of the electrodes per side wall of the reactor shaft, viewed in vertical longitudinal direction (L) of the reactor, is disposed in the middle of the reactor shaft at least in sections, or each of the electrodes per side wall is disposed at least above or below the middle of the reactor shaft.

19. The reactor of claim 16, wherein the electrodes are arranged such that these generate an electrical field which is at least intermittently homogeneous in sections and viewed over cross section.

20. The reactor of claim 16, wherein the reactor includes a reactor head and a reactor bottom, where the reactor head and the reactor bottom each have at least intermittently closable feed openings and discharge openings through which at least fluids or solids, especially particles, can be introduced or discharged, such that, for creation of a moving bed, particles are continuously introduced into the reactor shaft at least intermittently through the reactor head.

21. The reactor of claim 30, wherein the electrodes are arranged in such a way that they generate an electrical field aligned orthogonally at least in sections to the direction of movement of the particles of the moving bed that move through the reactor shaft.

22. A method at least for pyrolysis of hydrocarbon-containing fluids at least for production of at least hydrogen-containing fluids, comprising:
feeding hydrocarbon-containing fluids to a reactor shaft of a reactor in countercurrent to a moving bed of the reactor that consists of particles; and heating at least the particles of the moving bed or the hydrocarbon-containing fluids, by means of electrodes for generation of thermal energy up to a defined temperature in the range between 800-1600° C.

23. The method of claim 22, wherein the method is conducted in a reactor of claim 1.

24. The method of claim 22, wherein the particles of the moving bed migrate downward gravimetrically from a reactor head of the reactor to a reactor bottom of the reactor in vertical longitudinal direction (L) of the reactor.

25. The method of claim 22, wherein the electrodes generate an electrical field aligned orthogonally at least in sections to the direction of movement of the particles of the moving bed that move through the reactor shaft.

26. The method of claim 22, wherein a first heat integration zone (W1), a reaction zone (R), a heating zone (B) and a second heat integration zone (W2) are formed within the reactor shaft, where the individual zones, proceeding from the reactor bottom of the reactor to the reactor head of the reactor, viewed in vertical longitudinal direction (L) of the reactor are successive and at least partly overlap in sections.

27. The method of claim 26, wherein the pyrolysis takes place at least in the reaction zone (R) or in the heating zone (B).

28. The method of claim 22, wherein the hydrocarbon-containing fluids are already at least preheated in the first heat integration zone (W1) by the particles of the moving bed which have already passed through the heating zone (B) and move in countercurrent to the hydrocarbon-containing fluids.

29. The method of claim 28, wherein the particles of the moving bed that enter the reactor shaft are already at least preheated in the second heat integration zone (W2) by a heated hydrogen-containing fluid which flows in countercurrent to the particles of the moving bed, results from the hydrocarbon-containing fluids and has already passed through the heating zone (B) and released carbon.

30. The method of claim 22, wherein the carbon-laden particles in the moving bed are discharged from the reactor shaft via the reactor bottom of the reactor.
